(19) United States
(12) Patent Application Publication
(10) Pub. No.: US 2008/0085774 A1
(43) Pub. Date: Apr. 10, 2008

(54) Gaming Device with Embedded Data System

(76) Inventors: Mark B. Gagner, West Chicago, IL (US); Erhard W. Rathsack, Reno, NV (US)

Correspondence Address: SCHWEGMAN, LUNDBERG & WOESSNER, P.A., P.O. BOX 2938, MINNEAPOLIS, MN, 55402, US

(21) Appl. No.: 11/576,365

(22) PCT Filed: Sep. 28, 2005
(86) PCT No.: PCT/US05/35143

§ 371 Date: Mar. 30, 2007

Related U.S. Application Data
(60) Provisional application No. 60/614,825, filed on Sep. 30, 2004.

(51) Int. Cl. G06F 17/00

(52) U.S. Cl. 463/43

(57) ABSTRACT

Systems and methods for operating a gaming machine having an embedded data system on a persistent memory are disclosed. One aspect of the systems and methods includes providing a database manager that maintains the database on the persistent memory. The database may be a relational database, a hierarchical database, or an object oriented database. Critical data generated during the course of the operation of the gaming machine is stored in the database.

### RELATED APPLICATION

This application claims the priority benefit of U.S. Provisional Application Ser. No. 60/614,825 filed Sep. 30, 2004, the contents of which are incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2005, WMS Gaming, Inc. All Rights Reserved.

### FIELD

The present invention relates generally to gaming devices, and more particularly to a gaming device having an embedded data system.

### BACKGROUND

Today's gaming machine typically comprises a computerized system controlling a video display or reels that provide wagering games such as slots, video card games (poker, blackjack etc.), video keno, video bingo, video pachinko and other games typical in the gaming industry. Generally, the popularity of such machines with players is dependent on the likelihood (or perceived likelihood) of winning money at the machine and the intrinsic entertainment value of the machine relative to other available gaming options. Players also appreciate the reliability of a gaming machine, as do the casino operators. Shrewd operators consequently strive to employ the most entertaining, exciting, and reliable machines available because such machines attract frequent play and hence increase profitability to the operator.

Currently, microprocessor-based gaming machines, as well as most microprocessor-based devices use a direct access data storage mechanism commonly referred to in the industry as Random Access Memory (RAM). RAM is immediately accessible by the processor with no additional software required (as in the case of disk drives). The content of this memory is typically critical to the operation of the gaming machine and is continuously changing as it is read and written, as when game play occurs. One drawback of RAM is that it is power dependent and does not retain the current state of the computer's operation when power is removed.

A further drawback is that the data in RAM may be organized haphazardly for a given gaming application, and data types that are the same in different gaming applications may be organized differently in each gaming application.

### SUMMARY

Systems and methods for operating a gaming machine having an embedded data system are disclosed. One aspect of the systems and methods includes providing a database manager that maintains the database on the persistent memory. The database may be a relational database, a hierarchical database, or an object oriented database. Critical data generated during the course of the operation of the gaming machine is stored in the database.

The present invention describes systems, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a perspective view of a gaming machine embodying the present invention;

FIG. 2 is a block diagram of a gaming control system suitable for operating the gaming machine in FIG. 1;

FIG. 3A is a block diagram illustrating a database partition in a system memory of a gaming machine according to varying embodiments of the invention;

FIG. 3B is a block diagram illustrating a database partition in a persistent RAM of a gaming machine according to alternative embodiments of the invention.

FIG. 4 is a flowchart illustrating a method for providing an embedded data system on a gaming machine according to various embodiments of the invention.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The description of the various embodiments is to be construed as exemplary only and does not describe every possible instance of the invention. Numerous alternatives could be implemented, using combinations of current or future technologies, which would still fall within the scope of the claims. The following detailed description is, therefore, not to be taken in a limiting sense, and the scope of the present invention is defined only by the appended claims.

### Operating Environment

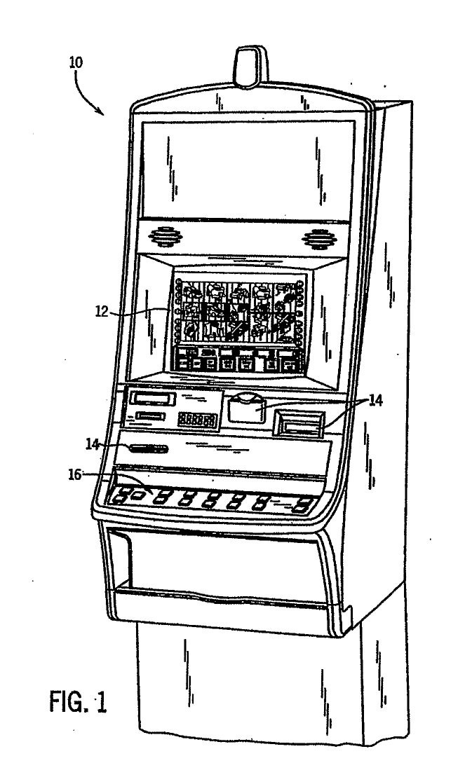

FIG. 1 illustrates an exemplary gaming machine 10, also referred to as a Video Lottery Terminal (VLT), in which embodiments of the invention may be implemented. In some embodiments, gaming machine 10 is operable to conduct a wagering game such as mechanical or video slots, poker, keno, bingo, or blackjack. If based in video, the gaming machine 10 includes a video display 12 such as a cathode ray tube (CRT), liquid crystal display (LCD), plasma, or other type of video display known in the art. A touch screen preferably overlies the display 12. In the illustrated embodiment, the gaming machine 10 is an “upright” version in which the display 12 is oriented vertically relative to a player. Alternatively, the gaming machine may be a “slant-top” version in which the display 12 is slanted at about a thirty-degree angle toward the player.

The gaming machine 10 includes a plurality of possible credit receiving mechanisms 14 for receiving credits to be used for placing wagers in the game. The credit receiving mechanisms 14 may, for example, include a coin acceptor, a bill acceptor, a ticket reader, and a card reader. The bill acceptor and the ticket reader may be combined into a single unit. The card reader may, for example, accept magnetic cards and smart (chip) cards coded with money or designating an account containing money.

In some embodiments, the gaming machine 10 includes a user interface comprising a plurality of push-buttons 16, the above-noted touch screen, and other possible devices. The plurality of push-buttons 16 may, for example, include one or more “bet” buttons for wagering, a “play” button for commencing play, a “collect” button for cashing out, a “help” button for viewing a help screen, a “pay table” button for viewing the pay table(s), and a “call attendant” button for calling an attendant. Additional game specific buttons may be provided to facilitate play of the specific game executed on the machine. The touch screen may define touch keys for implementing many of the same functions as the push-buttons. Other possible user interface devices include a keyboard and a pointing device such as a mouse or trackball.

A processor controls operation of the gaming machine 10. In response to receiving a wager and a command to initiate play, the processor randomly selects a game outcome from a plurality of possible outcomes and causes the display 12 to depict indicia representative of the selected game outcome. In the case of slots for example mechanical or simulated slot reels are rotated and stopped to place symbols on the reels in visual association with one or more pay lines. If the selected outcome is one of the winning outcomes defined by a pay table, the processor awards the player with a number of credits associated with the winning outcome.

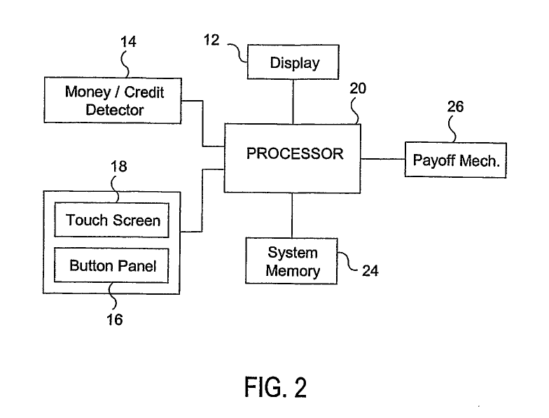

FIG. 2 is a block diagram of a control system suitable for operating the gaming machine 10. Money/credit detector 22 signals a processor 20 when a player has inserted money, tickets, tokens, cards or other mechanism for obtaining credits for plays on the gaming machine through credit mechanisms 14. Using a button panel 16 and/or a touch screen 18, the player may select any variables associated with the wagering game and place his/her wager to purchase a play of the game. In a play of the game, the processor 20 generates at least one random event using a random number generator (RNG) and provides an award to the player for a winning outcome of the random event. Alternatively, the random event may be generated by a remote computer using an RNG or pooling schema and then transmitted to the gaming machine. The processor 20 operates the display 12 to represent the random event(s) and outcome(s) in a visual form that can be understood by the player. In addition to the processor 20, the control system may include one or more additional slave control units for operating the display 12 and any secondary displays.

System memory 24 stores control software, operational instructions and data associated with the gaming machine. In one embodiment, the system memory 24 comprises a separate read-only memory (ROM) and battery-backed random-access memory (RAM). However, it will be appreciated that the system memory 24 may be implemented on any of several alternative types of memory structures or may be implemented on a single memory structure.

A payoff mechanism 26 is operable in response to instructions from the processor 20 to award a payoff to the player. The payoff may, for example, be in the form of a number of credits. The number of credits is determined by one or more math tables stored in the system memory 24.

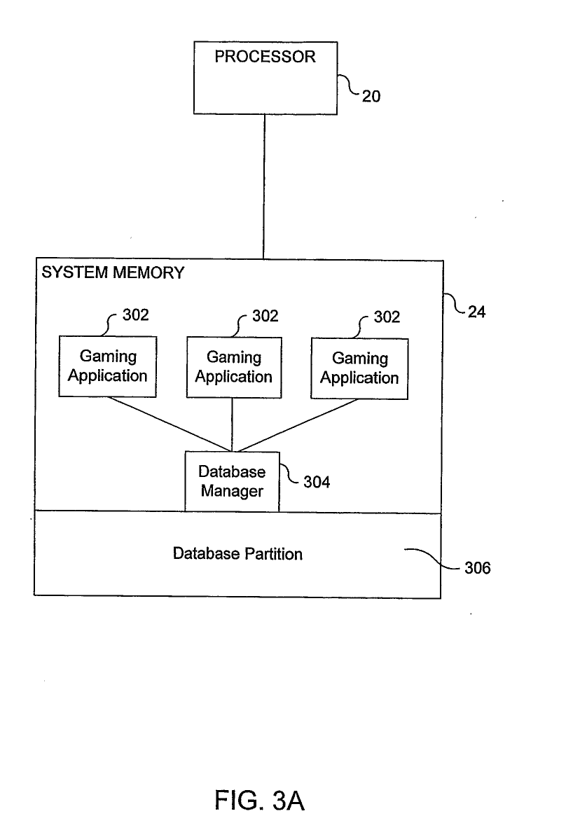

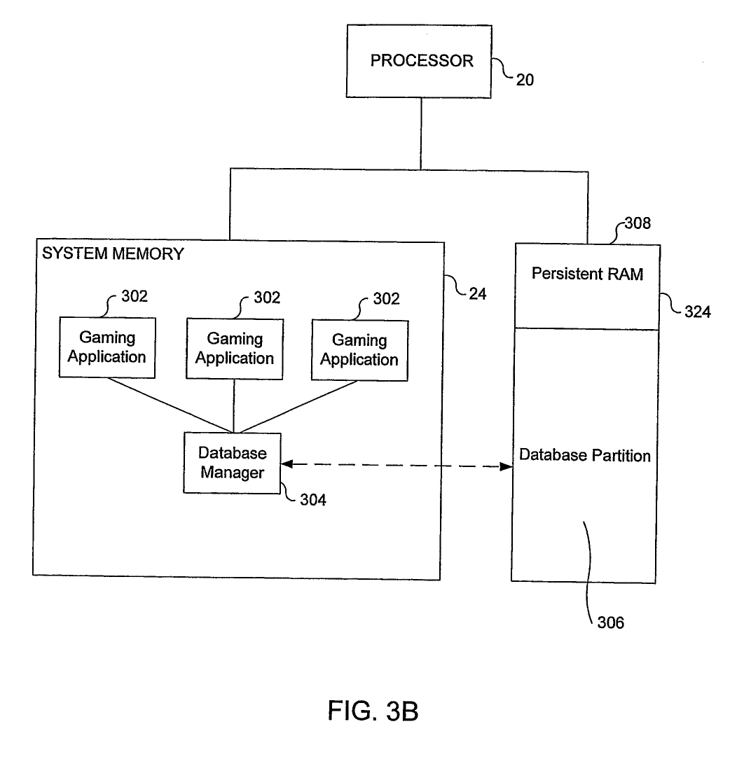

FIG. 3A is a block diagram providing further details regarding the interrelationship between the processor 20 and system memory 24 components in a gaming machine. In some embodiments, system memory 24 includes one or more gaming applications 302, and a database manager 304 executable by processor 20. In addition, system memory 24 may be partitioned, with one or more of the partitions comprising a database partition 306. Database partition 306 is maintained by database manager 304. Database partition 306 in some embodiments contains dynamic data, that is, data that may be read and written. However, database partition 306 may be a read-only partition containing static data, for example configuration related data.

In some embodiments, database manager 304 is a relational database manager that maintains a relational database in database partition 306. A relational database comprises a set of one or tables, where each table consists a fixed collection of columns (also called fields). An indefinite number of rows (or records) occurs within each table. However, each row typically has a unique primary key, which is a sort of name for that particular bundle of data. In addition, tables may have secondary keys. The secondary keys correspond with primary keys in other tables. The primary and secondary keys may be used to define relationships between the tables. Examples of such relationships include one-to-one relationships, many-to-one relationships, and/or many-to-may relationships between tables in the relational database.

In alternative embodiments, database manager 304 is a hierarchical database manager that maintains a hierarchical database in database partition 306. A hierarchical database generally comprises a predefined tree of data nodes. Each node may contain some identifying data, plus a set of subnodes of a specific child type. The number of subnodes can vary between sibling nodes at the same level, but the type of all “cousins” is typically identical. In hierarchical databases, data access is generally predictable in structure and typically comprises navigating the tree of nodes to the desired data elements.

In further alternative embodiments, database manager 304 is an object oriented database manager that maintains an object oriented database in database partition 306. Object databases (ODBMSs) in some ways are similar to the hierarchical model discussed above. Objects in an ODBMS comprise bundles of data and behaviors. In this sense, objects are similar to branch nodes of an HDBMS, which likewise contain a bundle of child nodes.

In addition, ODBMSs typically have the following characteristics:
Objects can be heterogeneous, and each contain a different collection of “owned” data
Objects can contain some inherent “intelligence”

Heterogeneous objects in an ODBMS allow each bundle of data to contain types of data appropriate to the object. A known object having an object identifier points to other objects, but the object does not necessarily have a rigidly uniform set of child nodes as in an HDBMS.

Because objects in an ODBMS can contain a variety of attributes and data, querying objects is often performed through a set of methods. Each object implements these methods in a way that is appropriate for itself. Each object has the necessary intelligence to know which is a relevant way of summarizing itself. Another way of thinking of an object's “intelligence” is in terms of the metadata that it carries.

In still further alternative embodiments, database manager 304 may be an XML database manager that maintains an XML database. An XML database provides search and retrieval capabilities that enable text and value indexing on document elements in collections of XML documents.

FIG. 3B is a block diagram providing further details regarding the interrelationship between the processor 20 and system memory 24 components in a gaming machine according to alternative embodiments of the invention. The components illustrated in FIG. 3B are similar those described above with reference to FIG. 3A, however in the exemplary embodiment described below, the NVRAM 308 (Non-Volatile RAM, also referred to as persistent RAM) separate from system RAM 24 is used to contain the database partition 306. The types of databases and database managers are the same as those described above with respect to FIG. 3A.

In some embodiments, two sections of NVRAM 308 may be used, with one section having a backup or redundant copy of the other section.

Additionally, in some embodiments, multiple sections of NVRAM 308 may contain different database partitions. These partitions may be read-only containing static data, read-write containing dynamic data, or any combination of the two.

In some embodiments, NVRAM 308 may comprise battery backed RAM, including battery backed SRAM (Static RAM). In alternative embodiments, NVRAM 308 may comprise MRAM (magnetoresistive or magnetic RAM). Generally speaking, MRAM is a non-volatile RAM memory technology that uses magnetic charges to store data instead of electric charges, such as those used in SRAM and DRAM technologies. In further alternative embodiments, NVRAM 308 may be FRAM (Ferroelectric RAM). MRAM and FRAM are desirable, because they do not require battery backup in order for the memory to retain data. It should be noted that any of these memory types may also be used for general purpose memory 24.

The data stored in database partition 306 and managed by database manager 304 may include critical data. Critical data is generally data that is maintained across reboots or power cycles for the gaming machine. Critical data may also include data that must be reported to one or more of the various regulatory agencies that control gaming in a jurisdiction. Examples of critical data may include one or more of the following:
Number of winning outcomes
Payout for the machine
Wagering details (e.g. number of lines wagered, number coins wagered etc.)
Coin-in amounts and denominations

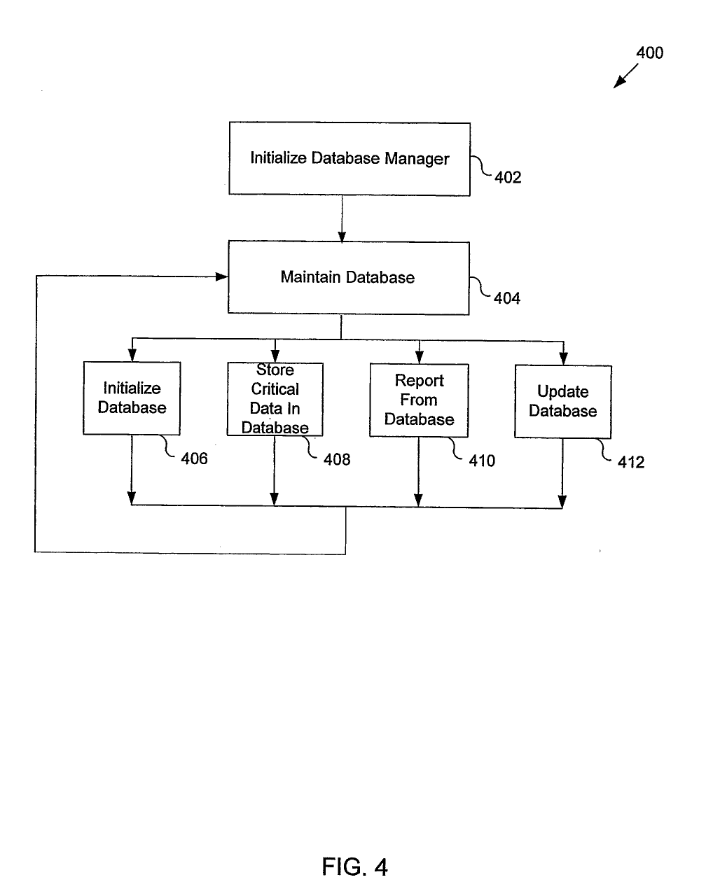

FIG. 4 is a flowchart illustrating a method 400 for providing an embedded data system on a gaming machine. The method to be performed by the operating environment constitutes computer programs made up of computer-executable instructions. Describing the method by reference to a flowchart enables one skilled in the art to develop such programs including such instructions to carry out the method on suitable processors for gaming machines (the processor or processors of the computer executing the instructions from computer-readable media including but not limited to RAM, ROM, flash memory CD-ROM, DVD-ROM, hard drives etc.). The method illustrated in FIG. 4 is inclusive of acts that may be taken by an operating environment executing an exemplary embodiment of the invention.

Method 400 begins by initializing a database manager for a database in an embedded data system (block 402). As noted above, the database may be a relational database, a hierarchical database, an object oriented database, or XML database. The inventive subject matter is not limited to any particular database type.

Next, the system maintains a database on a persistent memory for the gaming machine (block 404). Various actions may be performed in order to maintain the database, these actions include initializing the database (block 406), storing critical data in the database (block 408), generating a report from the database (block 410), or updating the database (block 412). These various actions may be performed under user control through a user interface to the database. In addition, these various actions may be performed under programmatic control, for example, by a gaming application running on the gaming machine.

Initializing the database (block 406) may include defining the data types and object allowed in the database. For example, in the case of a relational database, initializing the database may include defining the tables and columns that exist in the relational database. The tables and columns may include tables and columns that contain data that is required to be maintained in accordance with rules for a particular jurisdiction.

Storing critical data in the database (block 408) may include writing one or more critical data items to the database. In the case of a relational database, this may include creating new rows in the database, updating existing rows in the database, or deleting rows from the database. In the case of object oriented or hierarchical database, storing critical data may include adding, updating or removing object or nodes in the database.

Reporting from the database (block 410) may include generating a report containing one or more data items in the database. The report may be generated in an electronic form and sent from the gaming machine to a separate computer system for further analysis or reporting.

Updating the database (block 412) may include updating the data definitions for the database. In the case of a relational database, tables and/or columns may be added or removed. In the case of object oriented or hierarchical databases, object definitions or node definitions may be added or removed.

### CONCLUSION

Systems and methods for providing a gaming machine with an embedded data system have been disclosed. The systems and methods described provide advantages over previous systems. For example, the game framework and game libraries of various embodiments provide the opportunity add, update, and remove games and game configurations on a gaming machine without requiring physical access to the gaming machine or shutting the gaming machine down.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

What is claimed is:

1. A gaming machine comprising:
a processor and a persistent random access memory;
a gaming application executable by the processor;
a database manager communicably coupled to the gaming application and executable; and
a database partition within the persistent random access memory, the database partition controlled by the database manager.

2. The gaming machine of claim 1, wherein the database manager comprises a relational database manager.

3. The gaming machine of claim 1, wherein the database partition includes a plurality of tables.

4. The gaming machine of claim 3, wherein the plurality of tables include a plurality of rows and a plurality of columns.

5. The gaming machine of claim 1, wherein the database manager comprises an object oriented database manager.

6. The gaming machine of claim 5, wherein the database partition comprises an object database.

7. The gaming machine of claim 1, wherein the database partition comprises a hierarchical database partition.

8. The gaming machine of claim 1, wherein the persistent random access memory comprises a non-volatile memory.

9. The gaming machine of claim 1, wherein the memory comprises a read-only memory.

10. The gaming machine of claim 1, further comprising a second database partition within a second persistent random access memory, the second database partition controlled by the database manager.

11. A computer-implemented method for operating a gaming machine, the method comprising:
providing a nonvolatile memory for the gaming machine;
initializing a database manager; and
maintaining by the database manager a database on the nonvolatile memory.

12. The computer-implemented method of claim 11, wherein the database comprises a relational database.

13. The computer-implemented method of claim 11, wherein the database partition includes a plurality of tables.

14. The computer-implemented method of claim 13, wherein the plurality of tables are jurisdictional dependent.

15. The computer-implemented method of claim 13, wherein the plurality of tables include a plurality of rows and a plurality of columns.

16. The computer-implemented method of claim 11, wherein the database manager comprises an object oriented database manager.

17. The computer-implemented method of claim 16, wherein the database partition comprises an object database.

18. The computer-implemented method of claim 11, wherein the database partition comprises a hierarchical database partition.

19. The computer-implemented method of claim 11, further comprising storing critical data in the database.

20. The computer-implemented method of claim 11, further comprising generating a report from the database.

21. The computer-implemented method of claim 11, further comprising maintaining a second database within a second non-volatile memory, the second database controlled by the database manager.

22. A computer-readable medium having computer executable instructions for performing a method for operating a gaming machine, the method comprising:
providing a nonvolatile memory for the gaming machine;
initializing a database manager; and
maintaining by the database manager a database on the nonvolatile memory.

23. The computer-readable medium of claim 22, wherein the database comprises a relational database.

24. The computer-readable medium of claim 22, wherein the database partition includes a plurality of tables.

25. The computer-readable medium of claim 24, wherein the plurality of tables are jurisdictional dependent.

26. The computer-readable medium of claim 24, wherein the plurality of tables include a plurality of rows and a plurality of columns.

27. The computer-readable medium of claim 22, wherein the database manager comprises an object oriented database manager.

28. The computer-readable medium of claim 27, wherein the database partition comprises an object database.

29. The computer-readable medium of claim 22, wherein the database partition comprises a hierarchical database partition.

30. The computer-readable medium of claim 22, wherein the method further comprises storing critical data in the database.

31. The computer-readable medium of claim 22, wherein the method further comprises generating a report from the database.

32. The computer-readable medium of claim 22, wherein the method further comprises maintaining a second database within a second non-volatile memory, the second database controlled by the database manager.
